(19) United States
(12) Patent Application Publication
(10) Pub. No.: US 2004/0247226 A1
(43) Pub. Date: Dec. 9, 2004

(54) Polarization mode dispersion emulator

(76) Inventors: Jung-Hyung Pyo, Seoul (KR); Ho-Jin Jeong, Taejon (KR); Young-Wuk Lee, Taejon (KR); Byoung -Yoon Kim, Taejon (KR)

Correspondence Address: MARGER JOHNSON & MCCOLLOM PC, 1030 SW MORRISON STREET, PORTLAND, OR, 97205, US

(21) Appl. No.: 10/488,159

(22) PCT Filed: Oct. 18, 2001
(86) PCT No.: PCT/KR01/01753

(30) Foreign Application Priority Data
Sep. 5, 2001 (KR) 200154435

(51) Int. Cl. G02B 6/00

(52) U.S. Cl. 385/11

(57) ABSTRACT

A polarization mode dispersion (PMD) emulator is disclosed which can easily replicate PMD effect in a fiber span. The PMD emulator of the present invention comprises: at least two sections of polarization maintaining (PM) fiber, each having a predetermined PMD value; mechanical twisting means which twist one of neighboring ones among the PM fiber sections; a single mode fiber spliced in between neighboring PM fiber sections; wherein the single mode fiber has a small PMD value negligible compared to any of the PM fiber sections. According to the present invention, PMD effect can easily be replicated in the field of experiments studying PMD effect of a real fiber span.

### TECHNICAL FIELD

The present invention relates to a polarization mode dispersion (hereinafter, referred to as “PMD”) emulator, and more particularly, to a PMD emulator for reproducing PMD phenomenon of a real fiber optic transmission line easily.

### BACKGROUND ART

PMD is a phenomenon due to the birefringence of an optical fiber. Specifically, it is the phenomenon that an optical pulse that passed the optical fiber transmission system is broadened after the different spectrum components of the optical pulse experience different birefringences when the optical pulse having a limited pulse width is incident into the optical fiber having birefringence.

In optical telecommunications, PMD was a negligible physical amount before chromatic dispersion and optical loss did not become serious. However, now PMD becomes one of the most serious fault makers in a high-speed optic transmission system of 10 Gbit/s or more as dispersion shifted fiber (DSF) and chromatic dispersion compensation technology are developed. Especially the telecommunication distance of an optical transmission system is limited to 100 Km or 25 Km (if serious) since conventional optical cables installed for transmission network between stations have a great PMD value that is 0.5 to 2 ps/Km^{1/2}.

To overcome the problem caused by the PMD, required is a device to emulate a characteristic of the optical fiber system to cause PMD. So, a lot of efforts have been made to devise a PMD emulator to replicate precisely the PMD caused by the optical fiber transmission system. These PMD emulators are widely used to test PMD compensators.

FIG. 1 illustrates a structure of an all-fiber PMD emulator according to an example of the prior art. The PMD emulator 100 shown in FIG. 1 includes a plurality of polarization maintaining fiber sections 110 and a plurality of polarization controllers (PCs) 120 positioned between the adjacent polarization maintaining fiber sections 110. Here, each of polarization controllers 120 usually has at least two phase-retarders. Accordingly, a PMD emulator has a plurality of control parameters, so that it is difficult to make PMD values precisely.

FIG. 2 illustrates a structure of an all-fiber PMD emulator according to another example of the prior art. The PMD emulator 200 shown in FIG. 2 includes a plurality of polarization maintaining fiber sections 210 and a plurality of twistable connectors 220 positioned between the adjacent polarization maintaining fiber sections 210. These connectors 220 can change PMD values by changing birefringence axes of two adjacent polarization maintaining fiber sections 210. However, since the connectors 220 used in the PMD emulator having a structure described above connect the adjacent polarization maintaining fiber sections 210 not in fusion splicing method but in mechanical contacting method, a vacancy is made between the adjacent polarization maintaining fiber sections 210 as an inevitable consequence. Accordingly, optical loss is usually great and the optical loss is changed greatly when aligned.

FIG. 3 illustrates operation of an all-fiber PMD emulator according to another example of the prior art. The PMD emulator shown in FIG. 3 includes a strand of a polarization maintaining fiber 300 and means (not shown in FIG. 3) that twist some portions 310a, 310b and 310c of the polarization maintaining fiber 300 abruptly and mechanically in arrow directions. Since the portions of the polarization maintaining fiber 300 are twisted differently, the polarization of the light that travels through the polarization maintaining fiber 300 is controlled to generate the PMD. However, the PMD emulator having a structure described above is difficult to control and to generate a specific PMD value precisely. Referring to FIG. 3, the oblique lines drawn on the polarization maintaining fiber 300 only indicate mechanical twisting but do not mean the surface of the polarization maintaining fiber 300 is changed in structure.

### DETAILED DESCRIPTION OF THE INVENTION

Accordingly, it is an object of the present invention to provide a PMD emulator including components that have comparatively small control parameters and can generate the desired PMD value precisely.

It is an object of the present invention to provide a PMD emulator having a small optical loss.

It is an object of the present invention to provide a PMD emulator that is easy to control and generates a specific PMD value easily.

It is another object of the present invention to provide a PMD emulator having distribution similar to the Maxwellian distribution that is a distribution on the PMD of the real optical fiber transmission system.

To accomplish the above objects, there is provided polarization mode dispersion (PMD) emulator. The PMD emulator includes: at least two polarization maintaining (PM) fiber sections, each having a predetermined PMD value; mechanical rotating means for rotating one of two neighboring PM fiber sections among the PM fiber sections relative to the other one to align birefringence axes of the at least two PM fiber sections perpendicular to each other, in same direction or in a predetermined angle; and a single mode optical fiber spliced in between two neighboring PM fiber sections, and having a small PMD value that is negligible compared with PMD values of the polarization maintaining fiber sections.

### BRIEF DESCRIPTION OF THE DRAWINGS

FIG. 1 illustrates a structure of an all-fiber PMD emulator according to an example of the prior art;

FIG. 2 illustrates a structure of an all-fiber PMD emulator according to another example of the prior art;

FIG. 3 illustrates operation of an all-fiber PMD emulator according to another example of the prior art;

FIG. 4 is a schematic diagram of an all-fiber PMD emulator according to an embodiment of the present invention;

FIG. 5 illustrates circular birefringence induced in single mode optical fibers in a PMD emulator shown in FIG. 4; and

FIGS. 6A to 6D are graphs showing PMD values when polarization maintaining fiber sections are aligned in an angle in an all-fiber PMD emulator of the present invention.

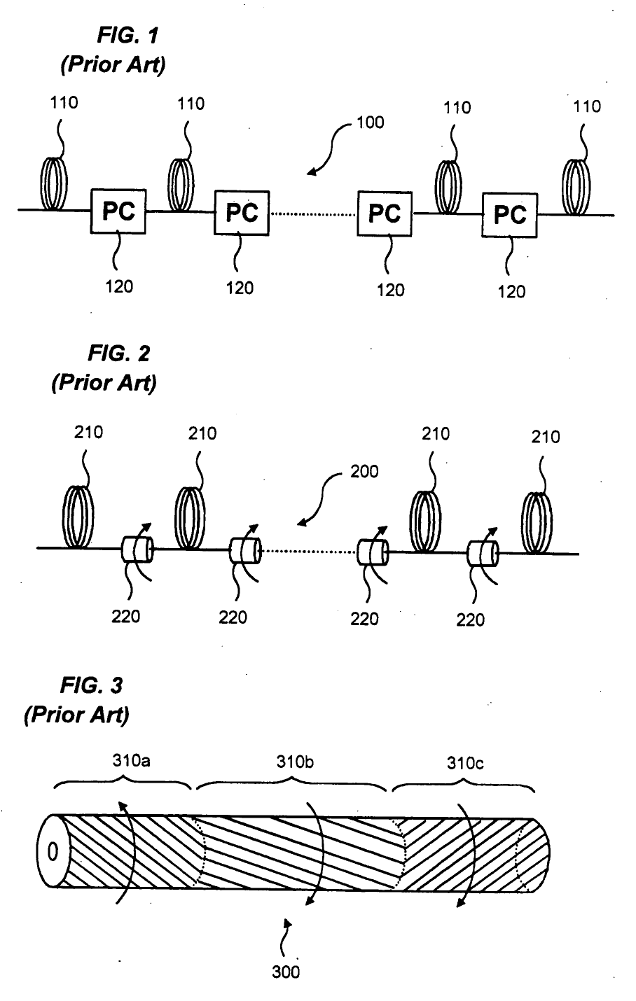

### BEST MODE FOR CARRYING OUT THE INVENTION

Hereinafter, preferred embodiments of the present invention will be described in detail with reference to the accompanying drawings.

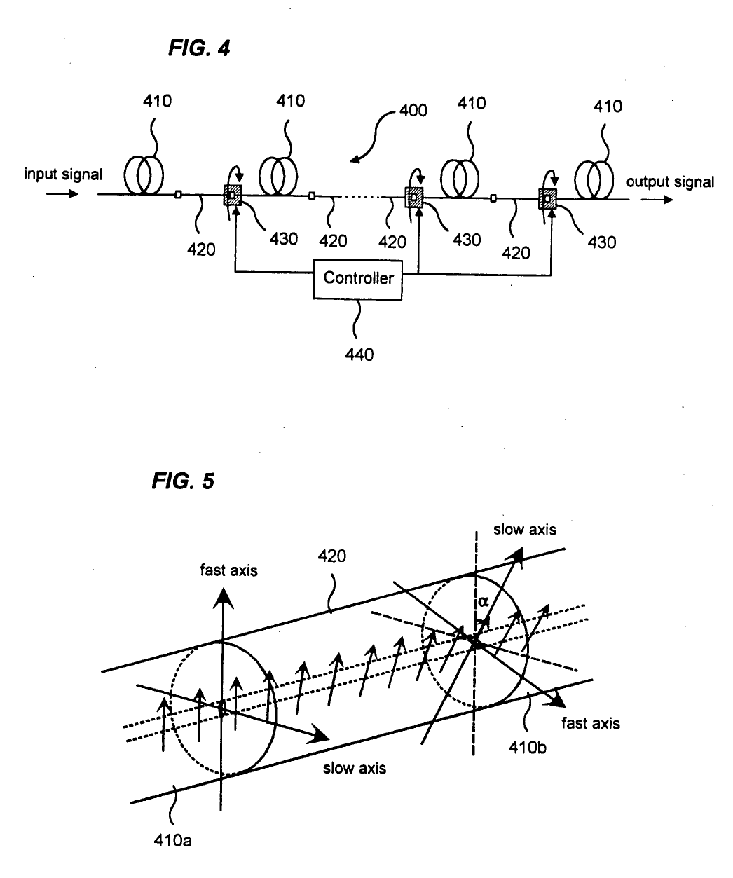

FIG. 4 is a schematic diagram of an all-fiber polarization mode dispersion (PMD) emulator according to an embodiment of the present invention. Referring to FIG. 4, in a PMD emulator 400, at least two polarization maintaining fiber sections 410 each of which has a predetermined PMD value are connected to single mode optical fibers 420 in fusion splicing and the single mode optical fibers 420 are interposed between the polarization maintaining (PM) fiber sections 410 and have a short length. The single mode optical fibers 420 have a small PMD value that is negligible compared with PMD values of the polarization maintaining fiber sections 410. On the other hand, one of portions connected in fusion slicing is provided with stepping motors 430 which can rotate one polarization maintaining fiber section relative to neighboring polarization maintaining fiber sections. A controller 440 applies an electrical signal to each of stepping motors 430 to drive the stepping motors 430. The controller 440 has a final PMD value inside generated by alignment combination of perpendicular and accordance of birefringence axes of the polarization maintaining fiber sections 410 and can align birefringence axis perpendicular to each other, in same direction or in a predetermined angle.

FIG. 5 illustrates circular birefringence induced in single mode optical fibers in a PMD emulator shown in FIG. 4.

It is assumed that two polarization maintaining fiber sections 410a and 410b are aligned in the way of fast axis-fast axis (slow axis-slow axis). To align them in the way of fast axis slow axis (slow axis-fast axis), the polarization maintaining fiber section 410b of a rear stage should be rotated. It is enough to twist it by 90 degree if circular birefringence is not caused when a single mode optical fiber 420 is twisted. However, because of the circular birefringence, the polarization axis of a light is rotated in the direction in which the optical fiber is twisted and the polarization axis of a light should be additionally rotated so that the two polarization maintaining fiber sections 410a and 410b are aligned in the way of fast axis-slow axis (slow axis-fast axis). Therefore, as shown in FIG. 5, the rotation angle of the polarization maintaining fiber section 410b should be 90+α degree. The amount of α is about 8% of the rotation angle.

The PMD value generated by the PMD emulator is determined by the alignment directions of the polarization maintaining fiber sections. For example, the polarization maintaining fiber section of the front stage is fixed and the polarization maintaining fiber section of a rear stage is rotated using a stepping motor (not shown in FIG. 5) installed on junction portion of a single mode optical fiber and a polarization maintaining fiber section of the rear stage. If so, alignment of the birefringence axes between polarization maintaining fiber sections can be changed. If the birefringence axes of two polarization maintaining fiber sections with the PMD values of T₁ and T₂ respectively are aligned in the same direction, that is, in the way in which the fast (slow) axis of the polarization maintaining fiber section in the front stage matches the fast (slow) axis of the polarization maintaining fiber section in the rear stage, the total PMD value is |T₁+T₂|. On the other hand, if the birefringence axes of two polarization maintaining fiber sections are aligned in the orthogonal direction, that is, in the way in which the fast (slow) axis of the polarization maintaining fiber section in the front stage matches the slow (fast) axis of the polarization maintaining fiber section in the rear stage, the total PMD value is |T₁−T₂|. If it is generalized into the case of the PMD emulator including N polarization maintaining fiber sections, the resultant PMD value is the absolute value of the value obtained by subtracting the sum of PMD values of polarization maintaining fiber sections aligned perpendicular to the first polarization maintaining fiber section from the sum of PMD values of polarization maintaining fiber sections aligned in parallel with the first polarization maintaining fiber section. By changing the alignment directions of the polarization maintaining fiber sections using birefringence axis rotating means, the PMD value can be changed. When all polarization maintaining fiber sections are aligned in the same direction, the PMD value is the sum of the PMD values of all polarization maintaining fiber sections and that is the maximum value. To generate a desirable PMD value in such a structure, the most suitable aligning method is found for the polarization maintaining fiber sections to align the fast (slow) axis of the polarization maintaining fiber sections to the fast or slow axis of the next polarization maintaining fiber sections. In this way, it is very simple to control since there are not many control parameters between the polarization maintaining fiber sections and alignment is changed for two cases of the fast axis and the slow axis.

On the other hand, as shown in FIG. 5, in rotating birefringence axis, the polarization maintaining fiber section 410b of the rear stage and the connection portion of the single mode optical fiber 420 are rotated with respect to the polarization maintaining fiber section 410a of the front stage so that the birefringence axis of the polarization maintaining fiber section 410b of the rear stage is rotated relatively with respect to that of the front stage. At this time, it should be rotated considering even circular birefringence caused by the twisted single mode optical fiber 420. Even though the polarization maintaining fiber section 410b of the rear stage is rotated physically by 90 degree with respect to the polarization maintaining fiber section 410a of the front stage, the polarization maintaining fiber section 410b of the rear stage is rotated less by the circular birefringence caused by the twisted single mode optical fiber 420. In this embodiment, the polarization maintaining fiber section 410b of the rear stage should be rotated more by about 8% with respect to 90 degree so as to change birefringence axis. Here, the single mode optical fiber needs to be short to have a negligible PMD value.

The description of the method of setting the PMD values of the polarization maintaining fiber sections to constitute a PMD emulator will be made.

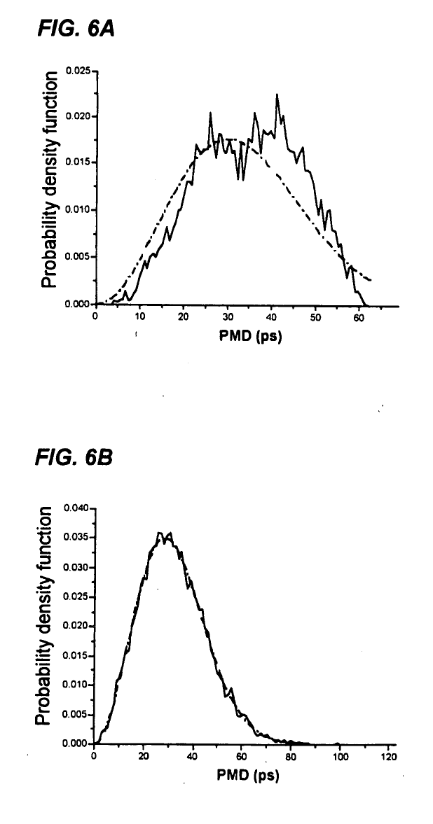

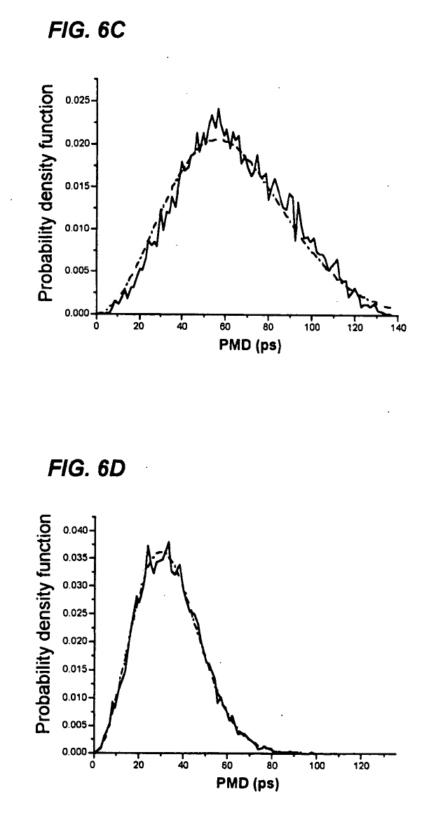

In the embodiment of the present invention, the PMD values of the polarization maintaining fiber sections to constitute a PMD emulator are set to be 2^{N-1}Tₘᵢₙ, where N is an integer, 1≦N≦NMAX, NMAX is an integer equal to or greater than 2 as the entire number of the polarization maintaining fiber sections and Tₘᵢₙ is a PMD value of the polarization maintaining fiber section having a minimum PMD value. In this structure, the total PMD value can be changed by every 2Tₘᵢₙ from Tₘᵢₙ as the minimum to the sum of the PMD values of the polarization maintaining fiber sections as the maximum. For example, if the minimal PMD of the polarization maintaining fiber section is determined to set Tₘᵢₙ to be 0.25 ps and the number of the polarization maintaining fiber sections is eight, eight polarization maintaining fiber sections having the PMDs of 0.25 ps, 0.5 ps, 1 ps, 2 ps, 4 ps, 8 ps, 16 ps and 32 ps respectively are needed. When using them, all PMD values can be generated by every 0.5 ps from 0.25 ps (32 ps−16 ps−8 ps−4 ps−2 ps−1 ps−0.5 ps−0.25 ps) as the minimum to 63.75 ps (32 ps+16 ps+8 ps+4 ps+2 ps+1 ps+0.5 ps+0.25 ps) as the maximum. In this case, when generating PMDs, stepping motors as rotating means between the adjacent polarization maintaining fiber sections are located to match the fast axes or the slow axes of the polarization maintaining fiber sections. The advantage of this structure is that the desired PMD resolution and the maximal PMD value can be determined by controlling Tₘᵢₙ and the number of the polarization maintaining fiber sections. If the polarization maintaining fiber sections are aligned in random angles, that is, with no relation to the birefringence axis, the resultant PMD values have a distribution different from Maxwellian distribution. FIG. 6A shows this result together with Maxwellian distribution. Solid lines of FIGS. 6A to 6D illustrate distributions of PMD. Dotted lines of FIGS. 6A to 6D show Maxwellian distribution.

The desirable function of the PMD emulator is to implement the PMD phenomenon of a real optical transmission line. This function can be obtained if the polarization maintaining fiber sections are aligned not as fast axis-fast axis or fast axis-slow axis specifically but in random angles. As an ideal case for this, it is known that the distribution of emulated PMD values should follow Maxwellian distribution by repeated angle alignments. The PMD values or the number of the polarization maintaining fiber sections are controlled to obtain this distribution.

The best method of obtaining the Maxwellian distribution is to make the PMD values of the polarization maintaining fiber sections be the same. In this case, if the polarization maintaining fiber sections are aligned to change from fast (slow) axes to fast axes or slow axes, the number of the intentionally generated PMD values is very small compared with 2^{N-1}Tₘᵢₙ structure. In this case, if the polarization maintaining fiber sections are aligned in random angles, Maxwellian distribution for a PMD value can be obtained as shown in FIG. 6B. Referring to FIG. 6B, in a PMD emulator comprised of twelve polarization maintaining fiber sections having PMD values of 10 ps, the polarization maintaining fiber sections are aligned in random angles and a measured PMD distribution is shown together with Maxwellian distribution. From FIG. 6B, it can be shown that the measured PMD distribution follows Maxwell distribution.

On the contrary, if the PMD values of the polarization maintaining fiber sections is set to be N²Tₘᵢₙ (where N is an integer, 2≦N≦NMAX+1, NMAX is an integer equal to or greater than 2 as the entire number of the polarization maintaining fiber sections and Tₘᵢₙ is a PMD value of the polarization maintaining fiber section having a minimum PMD value), the PMD values obtained when the polarization maintaining fiber sections are aligned do not have a constant interval as described above in the 2ⁿ⁻¹Tₘᵢₙ structure. In the case of FIG. 6C, a PMD emulator comprised of polarization maintaining fiber sections (Tₘᵢₙ=1 ps, NMAX=6) having PMD values of 4 ps, 9 ps, 16 ps, 25 ps, 36 ps and 49 ps aligns the polarization maintaining fiber sections in random angles and a measured PMD distribution is shown together with Maxwellian distribution.

In the other method, if polarization maintaining fiber sections are combined using the structures described above, the PMD emulator can be configured in which the polarization maintaining fiber sections of a first group have the same PMD values and those of a second group have 2^{N-1}Tₘᵢₙ. Here, the total PMD value of 2^{N-1}Tₘᵢₙ of the second group is some value around the PMD value of one polarization maintaining fiber section of the first group. In such a case, the possible PMD values are Tₘᵢₙ as a minimum and the resolution is 2Tₘᵢₙ. The maximum can be controlled by increasing the number of the polarization maintaining fiber sections having the same PMD. Maxwellian distribution for PMD value can be obtained as shown in FIG. 6D by aligning the polarization maintaining fiber sections in random angles. In the case of FIG. 6D, a PMD emulator in which ten polarization maintaining fiber sections having PMD value of 10 ps are defined as a first group and five polarization maintaining fiber sections respectively having PMD values of 0.5 ps, 1 ps, 2 ps, 4 ps, 8 ps are defined as a second group (corresponding to NMAX=5 and Tₘᵢₙ=0.5 ps in the 2^{N-1}Tₘᵢₙ structure) aligns the polarization maintaining fiber sections in random angles and a measured PMD distribution is shown together with Maxwellian distribution.

### Industrial Applicability

According to the PMD emulator of the above-described present invention, PMD value can be made to be an arbitrary desired value. The minimal PMD value and the number of the polarization maintaining fiber sections are changed to set the desired resolution and the maximal PMD value. In the experiment to study PMD phenomenon of a real optical transmission line, it can generate the PMD phenomenon of the real optical transmission system easily. It can be employed necessarily in a PMD compensator to compensate for PMD which is a great obstacle in a high-speed optical telecommunication.

It will be apparent to those skilled in the art that various modifications and variations can be made in the present invention. Thus, it is intended that the present invention covers the modifications and variations of this invention provided they come within the scope of the appended claims and their equivalents.

1. A polarization mode dispersion (PMD) emulator comprising:
at least two polarization maintaining (PM) fiber sections, each having a predetermined PMD value;
mechanical rotating means for rotating one of two neighboring PM fiber sections among the PM fiber sections relative to the other one to align birefringence axes of the at least two PM fiber sections perpendicular to each other, in same direction or in a predetermined angle; and
a single mode optical fiber spliced in between two neighboring PM fiber sections, and having a very small PMD value that is negligible compared with PMD values of the polarization maintaining fiber sections.

2. The PMD emulator according to claim 1, wherein the mechanical rotating means is a stepping motor.

3. The PMD emulator according to claim 2, further comprising:
a controller having information on a final PMD value generated by alignment combination of perpendicular and accordance of the birefringence axes of the PM fiber sections therein, for driving the stepping motors according to a PMD value inputted by a user.

4. The PMD emulator according to claim 1, wherein each of the polarization maintaining fiber sections has a PMD value of 2^{N-1}Tₘᵢₙ so that the PMD emulator generates PMD values from Tₘᵢₙ at minimum to Tₘᵢₙ(2^{NMAX-1}−1) at maximum with interval of 2Tₘᵢₙ, where N is an integer, 1≦N≦NMAX, NMAX is an integer equal to or greater than 2 as the entire number of the polarization maintaining fiber sections and Tₘᵢₙ is a PMD value of the PM fiber section having a minimum PMD value.

5. The PMD emulator according to claim 1, wherein the PM fiber sections have one PMD value.

6. The PMD emulator according to claim 1, wherein the PM fiber sections have a PMD value of N²Tₘᵢₙ, where N is an integer, 2≦N≦NMAX+1, NMAX is an integer equal to or greater than 2 as the entire number of the polarization maintaining fiber sections and Tₘᵢₙ is a PMD value of the polarization maintaining fiber section having a minimum PMD value.

7. The PMD emulator according to claim 1, wherein each of the PM fiber sections comprises:
a first group of PM fiber sections, each having a same PMD value; and
a second group of PM fiber sections, each having PMD of 2^{N-1}Tₘᵢₙ, where N is an integer, 1≦N≦NMAX, NMAX is an integer equal to or greater than 2 as the number of the polarization maintaining fiber sections belonging to the second group and Tₘᵢₙ is a PMD value of the polarization maintaining fiber section having a minimum PMD value among the polarization maintaining fiber sections belonging to the second group.
